(19) United States
(12) Patent Application Publication
(10) Pub. No.: US 2017/0229889 A1
(43) Pub. Date: Aug. 10, 2017

(54) MOBILE PHONE INTEGRATED CHARGER

(71) Applicant: Kyeongim SEO, Changwon-si, Gyeongsangnam-do (KR)

(72) Inventor: Kyeongim SEO, Changwon-si, Gyeongsangnam-do (KR)

(21) Appl. No.: 15/501,678

(22) PCT Filed: Jun. 22, 2015
(86) PCT No.: PCT/KR2015/006326

§ 371 Date: Feb. 3, 2017

(30) Foreign Application Priority Data
Aug. 4, 2014 (KR) 10-2014-0099733

(51) Int. Cl. H02J 7/00; H04B 1/3883

(52) U.S. Cl. CPC H02J 7/0044; H04B 1/3883

(57) ABSTRACT

The mobile phone integrated charger according to the present invention comprises: an extension frame provided with a first frame part which is extended in a horizontal direction, and further provided with second and third frame parts which cover both sides thereof with respect to the center in the longitudinal direction of the first frame part, wherein the second and third frame parts are slid in both side directions of the first frame part so that the length of the extension frame is extended; an extension case provided with first and second case parts, each having a side aperture and a top surface aperture on the side and the top surface thereof, wherein the second and third frame parts are coupled to the side aperture so that the extension case is slid in the longitudinal direction of the second and third frame parts; and a plug provided on the inside of each of the first and second case parts, the plug being slid and protruding from the top surface aperture of the first and second case parts, wherein the extension frame and the extension case are extended and then form a fixing structure at which the extension frame and the extension case are fixed, to be transformed to a state of use or a state of storage.

### BACKGROUND

Technical Field

The present invention relates to a mobile phone integrated charger, and more particularly to a mobile phone integrated charger having a plug that connects to a conventional electrical socket embedded in a mobile phone.

Background Art

In general, a charger for a mobile terminal is configured to have an adapter for transforming household AC voltage (AC 220/110V) to DC voltage and outputting it to a regulator, a regulator for maintaining the input voltage at a constant rate, the voltage applied to the charger through a household power cable, and a charging circuit for receiving the DC voltage and transforming it into a charging voltage to provide to a battery attached to the charger.

However, the mobile terminal has a disadvantage that a charger or a spare battery must be provided separately for long time use.

### SUMMARY

The present invention has been made to solve the above-mentioned problems, and it is an object of the present invention to provide a mobile phone integrated charger capable of charging a battery without using a separate charger.

It is another object of the present invention to provide a mobile phone integrated charger which can be extended and shrunken, effectively reducing the volume of a charger, enabling it to be inserted into a mobile phone.

Further, it is a further object of a mobile phone integrated charger according to the present invention to provide a mobile phone integrated charger capable of directly charging without a separate charger, wherein a component of the charger is provided at an appropriate position of the mobile phone, and the plug of the charger can be shrunken and inserted into the mobile phone, and the plug cord of the charger is pulled and the shape of the plug is changed to be inserted into an outlet.

A mobile phone integrated charger according to the present invention comprises: an extension frame provided with a first frame part which is extended in a horizontal direction, and further provided with second and third frame parts which cover both sides thereof with respect to the center in the longitudinal direction of the first frame part, wherein the second and third frame parts are slid in both side directions of the first frame part so that the length of the extension frame is extended; an extension case provided with first and second case parts, each having a side aperture and a top surface aperture on the side and the top surface thereof, wherein the second and third frame parts are coupled to the side aperture so that the extension case is slid in the longitudinal direction of the second and third frame parts; and a plug pin provided on the inside of each of the first and second case parts, the plug pin being slid and protruding from the top surface aperture of the first and second case parts, wherein the extension frame and the extension case are extended and then form a fixing structure at which the extension frame and the extension case are fixed, to be transformed to a state of use or a state of storage.

Further, the extension frame fixing structure comprises, at least two first coupling protrusions provided so as to be protruding at each outer circumference of both ends of the first frame part; and first coupling grooves which are coupled with the protruding members of the first frame part at each inner circumference of end parts in the direction of the second and third frame parts facing each other; wherein the first coupling protrusions of the first frame part are inserted and fixed into the first coupling grooves of the second and third frame parts after sliding the second and third frame parts on the first frame part towards both sides to extend them, and a fixing structure fixing the second and third frame parts with the extension case comprises, at least two second coupling protrusions provided to be protruding at each outer circumference end parts wherein the second and third frame parts are slid in side apertures of the first and second case parts; and second coupling grooves which are coupled with the second coupling protrusions of the second and third frame parts at the inner side of each side aperture of the first and second case parts; wherein the second coupling protrusions of the second and third frame parts are coupled and fixed to the second coupling grooves of the first and second case parts.

In addition, a wire storing member provided in the mobile phone for storing a wire member is further comprised.

Further, the plug pin is coupled in multiple stages in a longitudinal direction, to extend and shrink in the longitudinal direction, and the plug pin is rotated in one direction and locked to a groove to be fixed after being extended.

Further, an electricity connecting part which extends and shrinks by being connected at an inner side of the extension frame and plug pin in multiple stages is provided.

Further, the second case part is rotated at 360 degrees to couple the extension frame and the first case part, respectively.

According to the solutions of the above-mentioned problems, the mobile phone integrated charger according to the present invention has an effect of charging a battery in a conventional electric outlet without using a separate charger, thereby improving portability and ease of use.

Further, the mobile phone integrated charger according to the present invention has an effect of enabling a plug to be mounted on a mobile phone by being extended and shrunken to a minimum volume.

In addition, the mobile phone integrated charger according to the present invention has an effect of enabling the thickness of a general smartphone to be maintained while a charger is incorporated therein, and enabling the exterior form of the general smartphone to be maintained by minimizing the space for mounting a plug and the incision part where the plug enters and exits.

### BRIEF DESCRIPTION OF THE DRAWINGS

FIG. 1 is a perspective view of a mobile phone integrated charger according to an embodiment of the present invention.

FIG. 2 is a perspective view of a storage state of a plug of the mobile phone integrated charger according to an embodiment of the present invention.

FIG. 3 is a perspective view of the plug transformed into a use state according to an embodiment of the present invention.

FIG. 4 is a sectional view for illustrating each connecting structure of the plug according to an embodiment of the present invention.

FIG. 5 is an exploded view of the plug in a separated state according to an embodiment of the present invention.

FIG. 6 is a perspective view of an electricity connecting part according to an embodiment of the present invention.

FIG. 7 is a view of a structure of a coupling protrusion and a coupling groove spreading a frame according to a preferred embodiment of the present invention.

FIG. 8 is a perspective view for illustrating an extension case of a mobile phone integrated charger according to a preferred embodiment of the present invention.

### DETAILED DESCRIPTION

The specific details including the above-mentioned technical problems, technical solutions and advantageous effects of the present invention are comprised in the following detailed description taken in conjunction with the accompanying drawings. The advantages and features of the present invention and the manner of achieving them will become apparent with reference to the embodiments described in detail below with reference to the accompanying drawings.

Hereinafter, the present invention will be described in more detail with reference to the accompanying drawings.

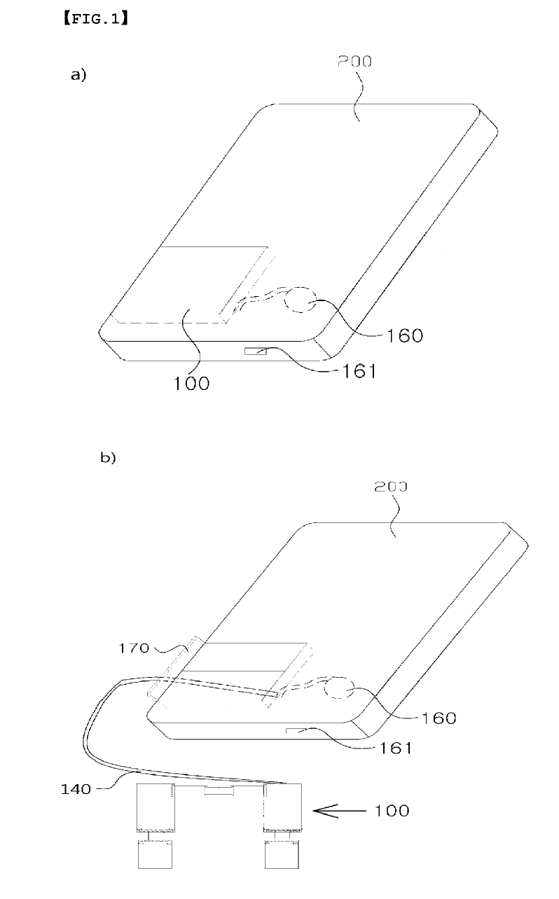

As shown in FIGS. 1 to 3, the mobile phone integrated charger according to the present invention may be configured to have an extension frame 110, an extension case 120, a plug pin 130, and a wire 140.

The present invention relates to a mobile phone integrated charger capable of enhancing portability and convenience by incorporating a mobile phone charger into a mobile phone.

The mobile phone integrated charger according to the present invention is provided with an extension frame 110.

The extended frame 110 may include a first frame part 111, a second frame part 112, and a third frame part 113.

The first frame part 111 is provided in a cylindrical shape extending horizontally.

The second and third frame parts 112, 113 are provided in a form that surrounds the outer circumference of both sides of the first frame part 111 on the basis of the middle of the extended longitudinal direction of the first frame part 111, so the second and third frames 112, 113 are each slid in both side directions of the first frame part 111 to extend the entire length of the extended frame 110.

That is, the extended frame 110 is provided with the first frame part 111 and is further provided with second and third frame parts 112, 113 surrounding the outer circumference of the first frame part 111, wherein the length thereof is extended by sliding each of the second and third frame parts 112, 113 to both sides respectively, on the basis of the center of the extended longitudinal direction of the first frame portion 111.

Also, the second case part 122 includes a wire member 140 that connects to the mobile phone 200.

Also, the mobile phone 200 is provided with a wire storing member 160 of a cord-drill structure and a storing member switch 161, provided so as to enable the wire member 140 to be selectively stored in the wire storing member 160 by pressing the storing member switch 161.

That is, by pressing the storing member switch 161, it plays the role of winding the wire member 140 connected to the second case part 122 at the mobile phone 200 into the inside of the mobile phone.

Wherein the wire storing member 160 is formed as a cord-drill structure for winding and storing a conventional wire. This elongates the wire after separating the plug 100 from the mobile phone 200, and for inserting the plug 100 back into the mobile phone 200, winds and stores the wire member 140 in the wire storing member 160.

Also, the extension case 120 is provided at both ends of the extension frame 110.

Wherein the extension case 120 is provided as first and second case parts 121, 122.

The first and second case parts 121, 122 are provided as a rectangular prism of six surfaces with a space formed therein, and at side and upper surfaces of each of the first and second case parts 121, 122, side apertures 121b, 122b and top surface apertures 121a, 122a are provided.

Also, the second and third frame parts 112, 113 are inserted and coupled to the side apertures 121b, 122b of each of the first and second case parts 121, 122, and the second and third frame parts 112, 113 inserted and coupled to the side apertures 121b, 122b respectively, are provided so as to be shrunk and extended by being slid to the inner side of the first and second case parts 121, 122.

Referring to FIG. 4, the first case part 121 is provided by an end of the second frame part 112 being inserted into the side aperture 121b and an end of the third frame part 113 is provided by being inserted into the side aperture 122b of the second case part 122. Also, each of the second and third frame parts 112, 113 are provided so as to be able to be shrunken and extended by being slid to the inner side of the first and second case parts 121, 122 through the respective side apertures 121b, 122b.

The plug pin 130 is provided inside each of the first and second case parts 121 and 122, and configured so as to enable it to be protruded by being slid to the top surface apertures 121a, 122a of the first and second case parts 121 and 122.

At this time, the plug pin 130 is formed in a structure in which multiple stages are coupled in a direction wherein it is protruded by being slid, provided so as to enable the extension and shrinkage thereof in a longitudinal direction.

That is, the plug pin 130 plays the role of applying electricity by being inserted into a conventional electric outlet.

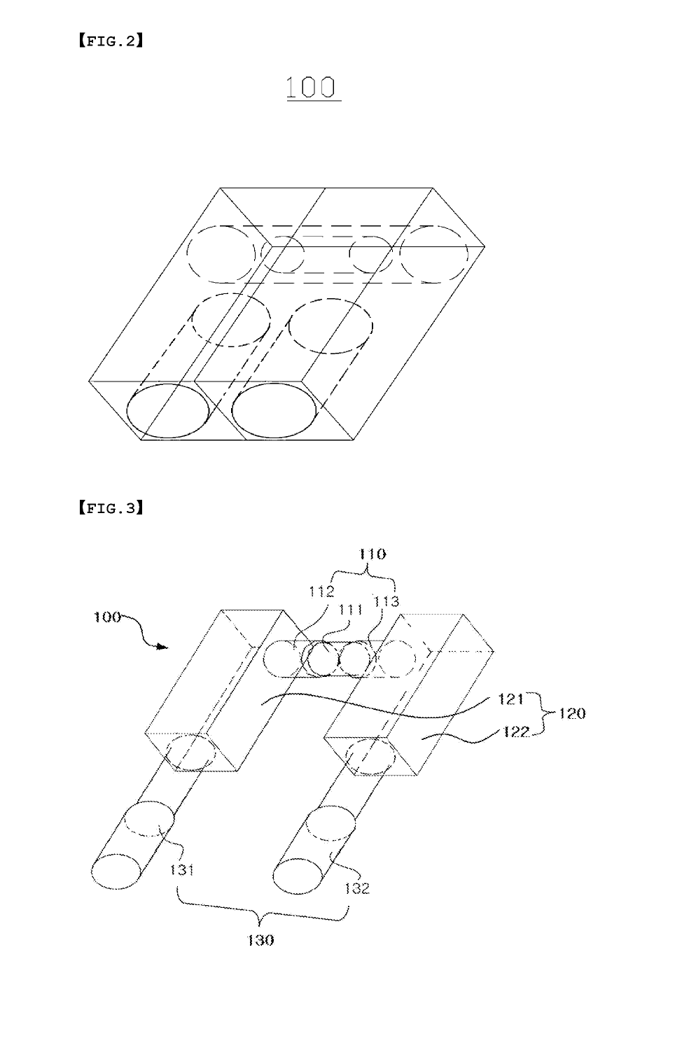

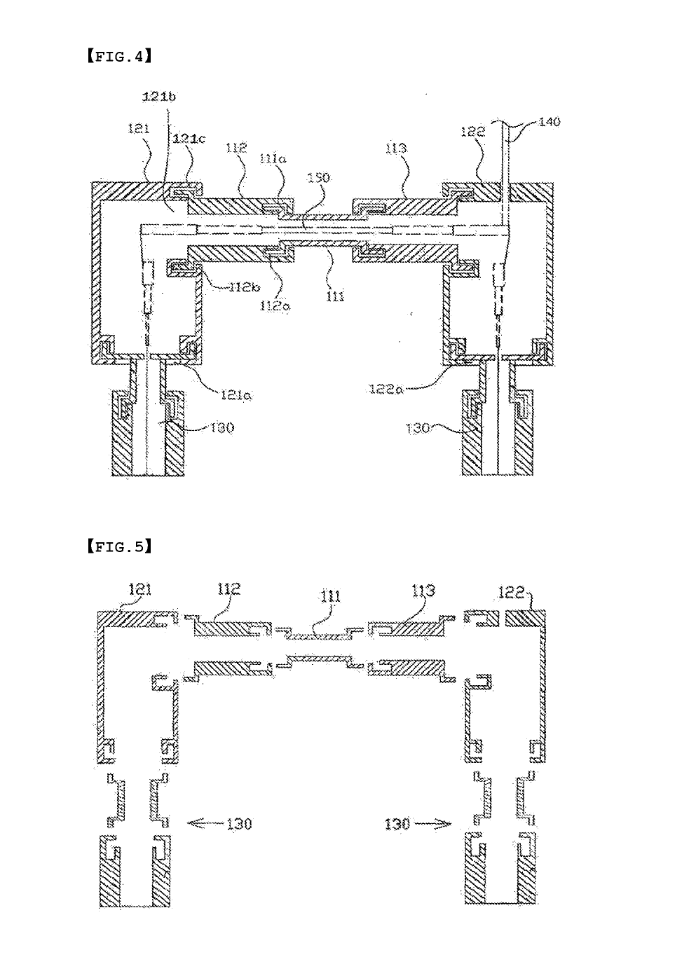

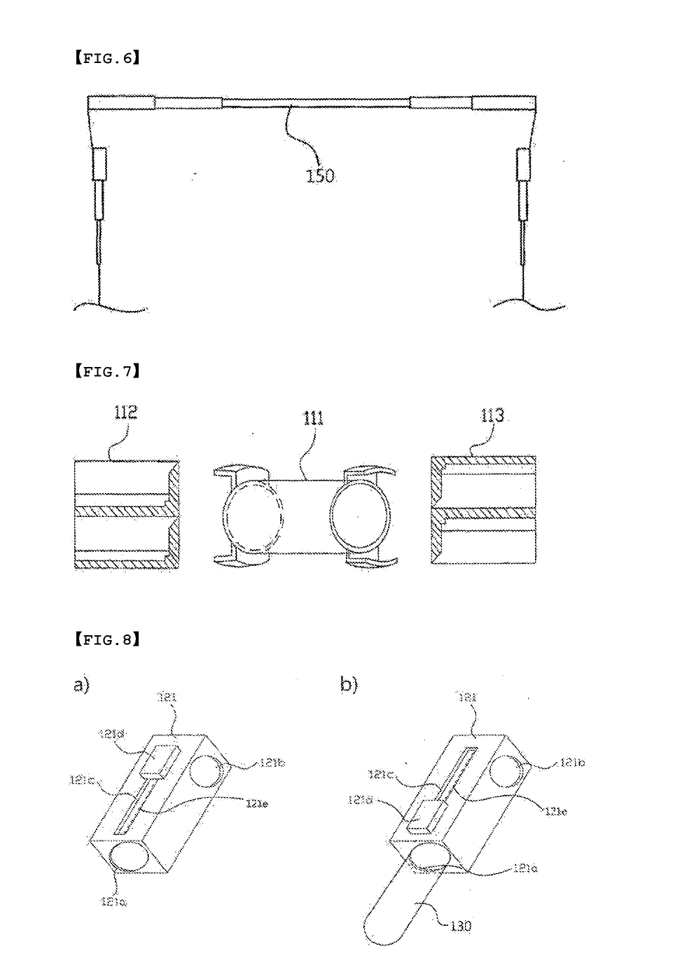

FIG. 2 is a view showing a storage state of the plug 100 according to the embodiment of the present invention, and FIG. 3 is a view showing a use state of the plug 100 according to the embodiment of the present invention.

The plug 100 will be described in more detail with reference to FIGS. 2 and 3.

First, the use state of the plug 100 is described in more detail with reference to FIGS. 3 and 4, and the plug pin 130 is pulled out from a storage state of the plug shown in FIG. 2. Also, the second case part 122 is pulled to one side. Then, the first, second, and third frame parts 111, 112, 113 that are inserted inside the first case part 121 and second case part 122 are extended to be changed into a use state as shown in FIG. 3.

At this time, the extension frame 110 and the extension case 120 are provided as a configuration in which they can be extended and then fixed to each other, and such a configuration will be described in more detail below with reference to FIG. 4.

Referring to FIG. 4, a pair of first coupling protrusions 111a are provided respectively at both ends of the first extended frame part 111.

Also, at one end of each of the second and third extension frame parts 112, 113, a pair of first coupling grooves 112a that are coupled to the pair of first coupling protrusions 111a provided at both ends of the first extension frame part 111 is provided, and at the other end of each of the second and third extension frame parts 112 and 113, a pair of second coupling protrusions 112b are provided.

Also, at the respective side apertures 121b, 122b of the first case part 121 and second case part 122, a pair of second coupling grooves 121c that are coupled to the second coupling protrusions of the second and third extension frame parts 112, 113 are provided.

That is, each of the first coupling groove 112a coupled with the first coupling protrusion 111a is provided in a pair, and the second and third extension frame parts 112, 113 are slid to both sides of the first extension frame part 111 to be extended and then the second case part 122 is rotated at 360 degrees, thereby engaging the first coupling protrusion 111a, the first coupling groove 112a, the second coupling protrusion 112b and the second coupling groove 121c that are provided at the respective extension frame 110 and extension case 120.

In this way, as in the above-described coupling structure, the plug pin 130 is also provided with the same coupling structure, so the extension frame 110, the extension case 120, and the plug pin 130 are extended, and they may be fixed firmly at an extended state.

Next, the storage state of the plug 100 is described in more detail with reference to FIG. 2. and the second case part 122 is rotated in a direction opposite to that of the direction it was rotated at 360 degrees when the plug 100 is in a use state, thereby releasing the engagement of the first coupling protrusion 111a, first coupling groove 112a, second coupling protrusion 112b, and second coupling groove 121c provided at the respective extension frame 110 and extension case 120. After that, the first and second case parts 121, 122 are pushed to a direction towards the first frame part 111 so the first, second and third frame parts 111, 112, 113 are inserted inside the first and second case parts 121, 122, and the plug pin 130 is also inserted in the first and second case parts 121, 122 to change it into a storage state in a rectangular shape and insert inside the mobile phone 200.

In this way, the plug 100 which was transformed into a storage state may be maintained in a very small, thin form, so there is an advantage in being able to be provided and used in conventional thin smart phones and different sorts of apparatuses that require charging.

Meanwhile, inside the plug 100 of the mobile phone integrated charger according to the present invention, an electricity connecting part 150 that is connected in a multiple staged manner like a conventional antenna to extend and shrink in a longitudinal direction may be comprised.

The electricity connecting part 150 is provided so as to be extended and shrunken when the plug 100 is transformed into a storage state and a use state.

At this time, the charger components provided in the mobile phone can be arranged at suitable positions, so the plug 100 according to the present invention may be provided so as to enable it to be transformed into the storage state and inserted into one side of the mobile phone.

The mobile phone integrated charger according to the present invention has an advantage that the plug 100 can be transformed into a storage state and be stored more effectively in a mobile phone.

Hereinafter, another embodiment of a mobile phone integrated charger according to the present invention will be described. All the elements of the other embodiment according to the present invention are the same as the embodiment of the mobile phone integrated integrated charger, and a guide path member 121c, slider member 121d, and a fixing member 121e may be further comprised.

FIG. 8 is a perspective view illustrating an extension case 121 of a mobile phone integrated charger according to the other embodiment of the present invention.

Referring to FIG. 8 for a more detailed description of the first case part 121, the first case part 121 may comprise a guide path member 121c, a slider member 121d, and a fixing member 121e.

The guide path member 121c is formed by a side surface of the first case part 121 being cut in a direction from its bottom to top.

Also, the slider member 121d is coupled to the plug pin 130 provided in a conventional cylindrical shape by a coupling ring, so as to reciprocate at the guide path member 121c, thereby making the plug pin 130 slide inside each of the first case part 121.

At this time, the plug pin 130 may be provided as a conventional plug pin 130 having a single stage instead of a structure of multiple stages being connected like the above-described embodiment.

At this time, the fixing member 121e is provided at the inner periphery of the guide path member 121c, thereby fixing the slider member 121d after it moves.

That is, as shown in FIGS. 8a and 8b, the slider member 121d is slid along the longitudinal direction of the guide path member 121c, thereby the plug 130 is provided so as to be protruded to enable it to be inserted into a conventional socket.

In an example, describing a configuration as mentioned above, the guide path member 121c, the slider member 121d, and the fixing member 121e provided at the extension case 120 may be formed as a configuration wherein, by a slider which moves along a guide path provided in a conventional stationary knife and a toothed fixing member provided at a side surface of a guide path member, the moved slider may be fixed.

So, it will be understood by those skilled in the art that the technical configurations of the present invention described above can be embodied in other specific forms without departing from the spirit and essential characteristics of the present invention.

Therefore, it should be understood that the embodiments described above are to be considered in all respects as illustrative and not restrictive, the scope of the invention being indicated by the appended claims rather than the foregoing description, and all changes or modifications that come within the scope of the equivalent concept are to be construed as being included within the scope of the present invention.

1. A mobile phone integrated charger comprising:
an extension frame comprising a first frame part which is extended in a horizontal direction, and second and third frame parts which cover both sides thereof with respect to the center in the longitudinal direction of the first frame part, wherein the second and third frame parts are slid in both side directions of the first frame part so that the length of the extension frame is extended;
an extension case provided with first and second case parts, each having a side aperture and a top surface aperture on the side and the top surface thereof, wherein the second and third frame parts are coupled to the side aperture so that the extension case is slid in the longitudinal direction of the second and third frame parts;
and a plug pin provided on the inside of each of the first and second case parts, the plug pin being slid and protruding from the top surface aperture of the first and second case parts,
wherein the extension frame and the extension case are extended and then form a fixing structure at which the extension frame and the extension case are fixed, to be transformed to a state of use or a state of storage.

2. The mobile phone integrated charger of claim 1, wherein the extension frame fixing structure comprises,
at least two first coupling protrusions provided so as to be protruding at each outer circumference of both ends of the first frame part; and
first coupling grooves which are coupled with the protruding members of the first frame part at each inner circumference of end parts in the direction of the second and third frame parts facing each other;
wherein the first coupling protrusions of the first frame part are inserted and fixed into the first coupling grooves of the second and third frame parts after sliding the second and third frame parts on the first frame part towards both sides to extend them,
and a fixing structure fixing the second and third frame parts with the extension case comprises,
at least two second coupling protrusions provided to be protruding at each outer circumference end parts wherein the second and third frame parts are sild in side apertures of the first and second case parts; and
second coupling grooves which are coupled with the second coupling protrusions of the second and third frame parts at the inner side of each side aperture of the first and second case parts;
wherein the second coupling protrusions of the second and third frame parts are coupled and fixed to the second coupling grooves of the first and second case parts.

3. The mobile phone integrated charger of claim 1, further comprising a wire storing member provided on the mobile phone for storing a wire member.

4. The mobile phone integrated charger of claim 1, wherein the plug pin is coupled in multiple stages in a longitudinal direction, to extend and shrink in the longitudinal direction, and the plug pin is rotated in one direction and locked to a groove to be fixed after being extended.

5. The mobile phone integrated charger of claim 1, wherein an electricity connecting part which extends and shrinks by being connected at an inner side of the extension frame and plug pin in multiple stages is provided.

6. The mobile phone integrated charger of claim 1, wherein the second case part is rotated at 360 degrees to couple the extension frame and the first case part, respectively.
